(19) United States
(12) Patent Application Publication
(10) Pub. No.: US 2026/0283220 A1
(43) Pub. Date: Sep. 24, 2026

(54) packaging container

(71) Applicant: Zhangjiagang Alien New Material Technology Co., Ltd, Suzhou (CN)

(72) Inventors: Lin ZHANG, Suzhou (CN); Qi ZHANG, Shenzhen (CN)

(21) Appl. No.: 19/681,127

(22) Filed: May 19, 2026

Related U.S. Application Data
(62) Division of application No. 18/566,592, filed on Jul. 5, 2021.

(30) Foreign Application Priority Data
Jun. 23, 2021 (CN) 202110695874.3

(51) Int. Cl. A24B 15/167; A24F 40/10; A24F 40/42; B01D 15/08

(52) U.S. Cl. CPC A24B 15/167; A24F 40/10; A24F 40/42; B01D 15/08

(57) ABSTRACT

A packaging container is disclosed in the present invention. The packaging container contains an electronic atomization liquid composition that comprises an electronic liquid, and an adsorption slow-release carrier in a solid state; the adsorption slow-release carrier is present in the electronic liquid; the adsorption slow-release carrier comprises a bio-based adsorption slow-release carrier that comprises at least one of biological fibers and biological cells; at least one of essence, nicotine, and nicotine salt is naturally pre-adsorbed in the bio-based adsorption slow-release carrier before the adsorption slow-release carrier is mixed with the electronic liquid to form the electronic atomization liquid composition; The packaging container comprises at least one of a barrel, a bottle, and an atomizing cartridge.

### CROSS-REFERENCE TO RELATED APPLICATIONS

This application is a division of the U.S. application Ser. No. 18/566,592 filed on Dec. 1, 2023, which is a continuation of International Application No. PCT/CN2021/104445, filed on Jul. 5, 2021, the entire disclosures of which are incorporated herein by reference.

### FIELD OF THE INVENTION

The present invention relates to the technology field of electronic cigarette, and in particular to an electronic atomization liquid composition and packaging container thereof.

### DESCRIPTION OF THE RELATED ART

Electronic atomization liquids, also named as atomizing liquids, e-cigarette liquids, e-liquids, etc., are usually overall clarified and transparent liquids, and can be sold in a variety of ways such as barrels, bottles, and atomizing cartridges, which are more flexible.

Since inception, e-cigarettes have been popular worldwide for their tar-free and other harm reduction selling points, and the users have exceeded hundreds of millions. However, the harms of e-cigarettes have not been thoroughly studied, and new harms have been neglected under the halo of harm reduction, for example, the concentrations of lead, cadmium, mercury, arsenic, nickel, chromium and other harmful elements in e-cigarettes aerosols are even more than those in the aerosols of traditional cigarettes. The main sources of harmful elements in e-cigarette aerosols are: raw materials of e-liquid, the producing process of the e-liquid, and the dissolutions from the atomizing cartridge components which soaked in the e-liquid for a long time, etc., these components include, for example, the atomizing cartridge shell body, metal conduit, e-liquid storage tank, metal heating wire, heating resistance layer, atomizing core and even sealing silica gel and so on. As well known: mercury, cadmium, lead and other harmful elements into human body are not easy to excrete out, and long-term accumulation will lead to dizziness, nausea, insomnia, abdominal pain and even death, which seriously threatens the safety of users.

In addition, users complain that the essences, cooling agents and nicotine contained in the e-liquid in the atomizing cartridge of the e-cigarette are decreasing day by day, and the e-cigarettes are even tasteless in the middle and late stages of using. Because the essences, the cooling agents and the nicotine are all volatile substances at room temperature, and the atomizing cartridge cannot be completely sealed, even when the e-cigarette does not vaping, the odor of the volatile substances can be smelled from the periphery of the atomizing cartridge, especially when the e-cigarette vaping, the e-liquid in the atomizing cartridge will also be warmed by the heat conducted from the atomizing core, causing accelerated escape and dissipation of volatile substances in the e-liquid, and their concentrations in the e-liquid will become lower and lower. In order to counteract the escape and dissipation of volatile substances in the e-liquid, whereby to keep sufficient concentrations in the middle and late stages of using, some people try to add more essences, cooling agents and nicotine to prepare the e-liquid, but these more substances make the e-liquid smell too strong in the early stage of using, which also worsens the vaping experience.

The fading of essences, cooling agents and nicotine is a problem that consumers have complained for a long time, and this problem has become more prominent under the trend of e-cigarettes developing towards large-capacity of e-liquid atomizing cartridges and more puffs. Nicotine salt is a weakly combined state of nicotine and organic acid, and although nicotine salt is more stable than free nicotine, the nicotine from the nicotine salt in e-liquid will still volatilize and escape when the e-liquid warmed by the heat conducted from the atomizing core. In the prior arts of e-cigarettes, beads preloaded with essences are respectively set in hardwares such as aerosol channel, silica sleeve, e-liquid storage cotton, filter cotton nozzle or sponge body, etc., and although there are some effect of enhancing or supplementing the aroma, the disadvantage is that after the beads burst, the essences are released suddenly and then quickly decreasing, resulting in too great difference experiences between before and after the beads burst, which needs to be improved.

### Contents of the Invention

The above problem will mainly be solved by the present invention providing an electronic atomization liquid composition and packaging container thereof, to reduce harmful elements such as lead, cadmium, mercury, arsenic, nickel, chromium and the likes in the e-liquid, to slow down the escape and dissipation of volatile components such as essences, cooling agents and nicotine in the e-liquid, and to reduce the odor fading in the middle and late using stages of e-cigarette.

In order to solve the above problem, a technical solution adopted in the present invention is providing an electronic atomization liquid composition, comprising e-liquid and adsorption slow-release carrier in solid state, wherein the weight share of the e-liquid in the electronic atomization liquid composition is from 10% to 99.9999%, and the weight share of the adsorption slow-release carrier in the electronic atomization liquid composition is in the range of 0.0001% to 90%, the adsorption slow-release carrier is located in the e-liquid to adsorb harmful elements in the e-liquid, and further to slow-release and keep concentration balance of volatile substances in the e-liquid.

The adsorption slow-release carrier is shaped in at least one of an irregular shape, a spherical shape, a block shape, a granular shape, a columnar shape, a pipe shape, a sheet shape, a letter, a word, a graphic, a symbol, a cartoon, a character, an animal, a plant and a trademark design, which is natural, routinely produced or made by using molds and cutting tools for molding, in particular, some of the letters, words, graphics, symbols, cartoons and characters, animals, plants and trademark shapes of the adsorption slow-release carriers, more personalized options, and further serve as promotional tools.

In a preferred embodiment of the present invention, the adsorption slow-release carrier adopts a combination of at least one of inorganic adsorption slow-release carrier, polymer adsorption slow-release carrier, and bio-based adsorption slow-release carrier, wherein the inorganic adsorption slow-release carrier includes but not limited to natural or artificial zeolite, molecular sieve, sepiolite, bentonite, montmorillonite, diatomite, silica gel powder, porous silica bead, activated carbon, activated alumina, nano-alumina, carbon nanotubes, etc.; the polymer adsorption slow-release carrier includes but not limited to polyurethane foam, resin, etc., and the bio-based adsorption slow-release carrier includes but not limited to chitosan, chitosan derivatives, chitin, chitin derivatives, wood fiber, peel, fruit grains, tree bark, tree leaves, tea leaves, tea stems, tobacco leaves, tobacco stems, mint leaves, flower leaves, flower buds, stamens, petals and flowers, etc.; among them, resins include but not limited to macroporous resins, ion exchange resins, etc., chitosan derivatives include but not limited to chitosan-bis(3-methylphenylcarbamate)-(butyramide), chitosan-bis(3,4-dichlorophenylcarbamate))-(butyramide), chitosan-bis(3,4-dichlorophenylcarbamate)-(cyclohexanecarboxamide) and the likes; chitin derivatives include but not limited to chitin, diacetyl butyryl chitin and chitin fiber, etc.; bark and leaves include but not limited to the bark and leaves of linalool and camphor trees that naturally absorb essences such as linalool; tea stems include but not limited to naturally adsorbed essences such as linalool, green leaf alcohol and so on.

Generally, menthol and other essences are naturally adsorbed in mint leaves, various essences such as alcohols, ketones, and esters are naturally adsorbed in flower leaves, buds, stamens, petals and flowers, linalool, green leaf alcohol, and other essences are naturally adsorbed in tea leaves and stems, nicotine molecules are naturally adsorbed in tobacco leaves and stems. Bio-based adsorption slow-release carriers such as bark, tea, mint leaves, tobacco leaves and flowers mainly rely on the natural adsorption of biological fibers and biological cells to store the essences, menthol and nicotine that they produced. In addition, bentonite, montmorillonite, diatomite, silica gel powder, carbon nanotubes, nano-alumina, chitosan and its derivatives, chitin and its derivatives, etc., located onto the surface of large-size adsorption slow-release carriers such as zeolite, molecular sieve, and activated carbon to form composite adsorption slow-release carriers, which can not only prevent the small-sized adsorption slow-release carriers being inhaled into the human body or making the e-liquid become turbid, but also increase the adsorption capacity of the adsorption slow-release carrier.

Generally, the above mentioned adsorption slow-release carrier can float and move in the e-liquid or sink to the bottom, but the cotton atomizing core or the ceramic atomizing core in the atomizing cartridge is electrically heated part that must be fixed in position, and in addition, the atomizing core can not be pre-mixed into the e-liquid to form an electronic atomization liquid composition before adding it to the atomizing cartridge, and the atomizing core will not be present in the bottled and barreled e-liquid to form an electronic atomization liquid composition, so the atomizing core in atomizing cartridge is not a component of the electronic atomization liquid composition of this invention.

The principle of adsorption and slow-release essences, ice cooling agents and nicotine of the adsorption slow-release carrier is: the inorganic adsorption slow-release carrier, polymer adsorption slow-release carrier and bio-based adsorption slow-release carrier contain at least one of the hydroxyl(—OH), carboxyl(—COOH), amino(—NH2) and amido(—NHCOCH3) as chemical group; essences are mostly composed of hydrocarbons, alkenes, alcohols, aldehydes, ethers, ketones, acids, phenols, esters, terpene, sulfur-containing or nitrogen-containing compounds, etc., with the molecular weight of less than 300, and essences, cooling agents and nicotine are active small-molecule organics with their own chemical groups; essences, cooling agents and nicotine are easily absorbed by the adsorption slow-release carrier through chemical groups attraction, and the natural nicotine, menthol or essence in the bio-based adsorption slow-release carriers such as tobacco leaves, tea leaves, mint leaves, flower leaves, buds and flowers will be adsorbed and stored by their biological fibers and biological cells. However, the adsorption slow-release carrier does not have strong adsorption force on the essence, cooling agent and nicotine molecules. In the electronic atomization liquid composition, the essence, cooling agent and nicotine molecules adsorbed by the adsorption slow-release carrier will gradually break free and slowly release into the e-liquid, that is slow-release, especially when the concentration of essence, cooling agent and nicotine in the e-liquid decreasing, as well as the adsorption slow-release carrier is warmed up by the heat conducted from the atomizing core in the e-liquid.

The principle of adsorbing harmful elements in e-liquid by the adsorption slow-release carrier is that: the lone pairs of electrons on the oxygen, nitrogen and other atoms in the chemical groups of some adsorption slow-release carriers can be put into the empty orbitals of cations of lead, cadmium, mercury, arsenic, nickel, chromium, etc., forming covalent bonds, and having complexation reactions with these harmful elements, so as to chemically adsorb and complex the harmful elements, this kind of adsorption slow-release carriers are such as chitosan and its derivatives, chitin and its derivatives and other bio-based adsorption slow-release carriers; some adsorption slow-release carriers contain negative electrochemical groups such as —OH, —COOH, —NH2 or —NHCOCH3, which are easy to adsorb and complex the cations such as lead, cadmium, mercury, arsenic, nickel, chromium and so on, this kind of adsorption slow-release carriers are such as activated carbon, diatomite, and other inorganic adsorption slow-release carriers which containing silica or carbon atoms; some adsorption slow-release carriers containing polar groups such as ether groups, amino groups, ester groups, urea group, etc., which can adsorb and complex cations of lead, cadmium, mercury, arsenic, nickel, chromium and so on, such adsorption slow-release carriers are polyurethane foam, etc.; some adsorption slow-release carriers can adsorb and complex these harmful elements through ion exchange, and the general formula of the chemical reaction is A+B−+C+→B+C−+A+, in which A+ is the cation contained in the adsorption slow-release carrier, B− is the skeleton or substrate of the adsorption slow-release carrier, and C+ is the cation of harmful element in the e-liquid, for example, zeolite, molecular sieves, and resins generally contain Na+, Al3+, H+, etc, and bio-based adsorption slow-release carriers such as fruit peels generally contain H+; some adsorption slow-release carriers employ the groups of —COOH, —NH2, —SH, —OH and —PO43-, which from their own biological fibers, biological cells, polysaccharides, pectin and proteins, chemically complexation with cations of lead, cadmium, mercury, arsenic, nickel and chromium to adsorb these harmful elements in e-liquid, this kind of adsorption slow-release carriers are such as wood fiber, fruit peel, fruit grain, bark, leaves, tea, tobacco leaves, mint leaves, flower leaves, buds, petals, flowers and other bio-based adsorption slow-release carriers.

In a preferred embodiment of the present invention, the adsorption slow-release carrier is modified by soaking in alkaline solution, acidic solution, hydrogen peroxide or other reagents solutions, and the modified adsorption slow-release carrier will improve the capacity to adsorb and complex harmful elements such as lead, cadmium, mercury, arsenic, nickel, chromium, etc., by increasing the number of original chemical groups or modified with other new chemical adsorption groups, for example, nitric acid immersion can significantly increase the activated carbon surface hydroxyl carboxyl group as well as the capacity of complexing metal ions, soaking in hydrogen peroxide can increase the number of hydroxyl groups on the surface of zeolite, soaking chitin in thioglycolic acid and sulfuric acid aqueous solution can modify sulfhydryl (—SH) and improve the capacity of chitin adsorbing metal ions, soaking in sodium hydroxide aqueous solution can expand the pore size of molecular sieve to promote the diffusion of adsorbing substances into the pores, as well as can reduce the silica-aluminum ratio of molecular sieve molecules to improve the adsorption and exchange capacity with metal cations.

In a preferred embodiment of the present invention, small pores are provided in the adsorption slow-release carrier, which may be microscopic pores, and the adsorption slow-release carrier is preferably natural or artificial porous carrier, which improves the adsorption capacity of nicotine, cooling agents and essences, as well as the ability to adsorb and complex harmful elements in e-liquid. The porous inorganic adsorption slow-release carriers such as zeolite, molecular sieve, sepiolite, bentonite, montmorillonite, diatomite, silica gel powder, porous silica beads, activated carbon, activated alumina, nano-alumina, carbon nanotubes, etc., and the polyurethane foam, resin and other polymer adsorption slow-release carriers, as well as chitosan and its derivatives, chitin and its derivatives, wood fiber and other bio-based adsorption slow-release carriers are all natural or artificial porous substances. In fact, fruit peel, bark, tea leaves, etc., have also been proved to be natural porous substances with good surface area and adsorption capacity. Although the pore sizes of porous adsorption slow-release carriers vary from femtometer, nanometer, micrometer to millimeter, they are much larger than the size of organic molecules, such as nicotine, ice cooling agents and essences, etc.; the surface area of the above mentioned porous adsorption slow-release carriers is huge, and there are a large number of chemical adsorption groups such as hydroxyl groups and carboxyl groups on the hole walls, which can increase the adsorption capacity of essences, cooling agents and nicotine in e-liquids, as well as the adsorption and complexation capacity of harmful elements such as lead, cadmium, mercury, arsenic, nickel and chromium in e-liquids.

To the inventor's surprise: porous adsorption slow-release carriers such as activated carbon, zeolite, molecular sieve, resin, tea, and the likes, can further absorb slightly soluble terpenes and other essences in e-liquid, resulting in the e-liquid of the electronic atomization liquid composition more clearer and transparent than before.

In a preferred embodiment of the present invention, before the absorption slow-release carrier mixing with e-liquid to form the electronic atomization liquid composition, at least one of essence, cooling agent, nicotine and nicotine salt is pre-adsorbed in the absorption slow-release carrier, wherein nicotine is derived from plant extraction or artificial synthesis; nicotine salt is the reaction product of organic acid with nicotine; essence includes sweetener, fruit essence, meat essence, tobacco essence, mint essence, food essence, etc., such as linalool essence, β-damascenone essence, and so on; ice-cooling agent includes menthol, WS-23 (N-ethyl-L-menthol formamide), WS-3 (menthol amide), etc.; the nicotine, essence, cooling agent, e-liquid, and adsorption slow-release carrier are all commercially available items, and the electronic atomization liquid composition produced by mixing the adsorption slow-release carrier into the e-liquid according to the above ratio can be operated well by person skilled in the art without creative labor. The adsorption slow-release carrier pre-adsorbs an appropriate amount of essence, cooling agent, nicotine, nicotine salt and other substances, and then mixes with the e-liquid to form the electronic atomization liquid composition, which avoiding too strong smell in the early stage of the e-liquid, and improving the using experience in the middle and late stages of e-cigarettes. The reason is analyzed as follows: the pre-adsorbed essence, ice cooling agent, nicotine and nicotine salt of the adsorption slow-release carrier by the surfaces and pore walls are in weak adsorption state of intermolecular force, after mixing with e-liquid to form electronic atomization liquid composition, the adsorption slow-release carrier will slowly release the above mentioned adsorbed substances and effectively replenish the essence, cooling agent and nicotine that are gradually escaping and losing in the e-liquid, and improve the vaping experience of the e-cigarette in the middle and late stages. Moreover, in the early stage of vaping, due to the high concentration of essence, cooling agent and nicotine in the e-liquid, the release of essence, cooling agent and nicotine from the adsorption slow-release carrier to the e-liquid is very little, which will not cause the smell to be too strong in the early stage. The function of adsorption slow-release carrier adsorbing essence, ice cooling agent, nicotine, nicotine salt and other substances is directly adsorption of their liquid or gas, and the adsorption can be occurred at low temperature, room temperature or high temperature, and the adsorption can be occurred at low pressure, normal pressure or high pressure, and the inventor finds that the capacity of the adsorption slow-release carrier absorbing volatile substances such as essence, cooling agent and nicotine is promoted when the adsorption occurs at low temperature or at low pressure.

In a preferred embodiment of the present invention, the e-liquid is a mixture of at least one of nicotine, nicotine salt, propylene glycol, glycerin, essence, water, and cooling agent. The nicotine, nicotine salt, essence, and ice-cooling agent can be replenished into the e-liquid by the adsorption slow-release carrier automatically to balance the volatile escape and consumption, so as to solve the problem that the taste fading of e-cigarettes in the middle and late vaping stages, and the adsorption slow-release carrier can also absorb and complex harmful elements such as lead, cadmium, mercury, arsenic, nickel, chromium, and the likes, in the e-liquid.

In order to solve the above mentioned problems, another technical solution adopted by the present invention is to provide packaging container for the electronic atomization liquid composition, and the packaging container contains the above mentioned electronic atomization liquid composition.

In a preferred embodiment of the present invention, the packaging container includes one or more of barrel, bottle and cartridge.

In a preferred embodiment of the present invention, the cartridge includes but not limited to cartridge-changing closed type e-liquid atomizing cartridge, cartridge-changing open type e-liquid atomizing cartridge, disposable e-cigarette with closed e-liquid storage cartridge, the e-liquid storage cartridge for high-power e-cigarette, etc., and the size can be changed varily or specially designated according to the shape of the adsorption slow-release carrier.

The beneficial effects of the present invention are: an electronic atomization liquid composition and packaging container thereof disclosed in the present invention, the essence, cooling agent and nicotine in e-liquid, etc., can be absorbed by the adsorption slow-release carrier in the electronic atomization liquid composition, or the essence, cooling agent, nicotine and nicotine salt can be pre-absorbed by the adsorption slow-release carrier before mixing into the electronic atomization liquid composition, and then slow-release into the e-liquid, replenishing same that volatiled and constantly lost in e-liquid, which can improve the using experience in the middle and late stages of e-cigarettes. In addition, the adsorption slow-release carrier can also absorb harmful elements such as lead, cadmium, mercury, arsenic, nickel, and chromium in e-liquid, which can reduce the entry of these harmful elements into the aerosol and human body, improving the safety of e-cigarettes.

### Mode of Carrying Out the Invention

The following will clearly and completely describe the technical solutions in the embodiments of the present invention. Obviously, the described embodiments are only some of the embodiments of the present invention, rather than all the embodiments. Based on the embodiments of the present invention, all other embodiments obtained by person skilled in the art without creative efforts belong to the protection scope of the present invention.

Embodiments of the invention include:

A nicotine salt prepared by reaction of 30 parts by weight of plant nicotine with purity of 99.7% and 10 parts by weight of benzoic acid, 5 parts by weight of commercial WS-23 ice-cooling agent (C13H25NO) with purity of 97%, 5 parts by weight of linalool essence (C10H18O) with pure of 98%, 450 parts by weight of propylene glycol and 500 parts by weight of glycerol, are evenly mixed to prepare 1000 parts by weight of e-liquid with the nicotine content of about 3 wt %, labeled as e-liquid X.

3 parts by weight of synthetic nicotine with purity of 99.8%, 6 parts by weight of menthol (C10H20O) with purity of 98%, 1 part by weight of β-damascenone (C13H20O) with purity of 99%, 490 parts by weight of propylene glycol and 500 parts by weight of glycerol are uniformly mixed to prepare 1000 parts by weight of e-liquid with the nicotine content of about 0.3 wt %, which is labeled as e-liquid Y.

In order to analyse and test the samples taken from the atomizing cartridges, the same open type e-cigarettes are used in the following the embodiments as those used in the comparative examples, in addition, the electronic atomization liquid composition in the present invention can also be applied to other types e-cigarettes and their e-liquid atomizing cartridges, such as cartridge-changing closed type e-cigarettes, disposable e-cigarettes, high-power e-cigarettes, low-power e-cigarettes, as well as their e-liquid atomizing cartridges, etc.

In order to simulate the usage scenarios and unify the test and comparison conditions, the e-cigarettes in the following comparative examples and the embodiments are naturally placed indoors after every 50 puffs, and another 50 puffs are taken after an interval of 24 hours, and total 500 puffs are continuously taken by this manner. Concentration changes of nicotine, ice cooling agent, essence, lead, cadmium, mercury, arsenic, nickel, chromium are detected after 0 puff, 50 puffs, 100 puffs, 150 puffs, 200 puffs and 500 puffs with the gas chromatography, inductively coupled plasma mass spectrometer and other instruments. The above preparation of e-liquid, sampling, and analysis and testing are common tasks in this field that can be implemented without any other creative labor.

### Comparative Example 1

Take 3 g of e-liquid X and inject it into the atomizing cartridge of an open type e-cigarette, and the concentration changes of nicotine, WS-23 ice-cooling agent, linalool essence, lead, cadmium, mercury, arsenic, nickel, and chromium in the e-liquid X in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Comparative example 1, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 29910 | 26925 | 24223 | 21838 | 19734 | 12561 |
| WS-23 | 4850 | 4368 | 3921 | 3539 | 3218 | 2031 |
| Linalool | 4900 | 4408 | 3965 | 3571 | 3233 | 2058 |
| Lead Ion | 0.492 | 0.511 | 0.552 | 0.582 | 0.613 | 0.714 |
| Cadmium Ion | 0.198 | 0.252 | 0.281 | 0.311 | 0.352 | 0.412 |
| Mercury Ion | 0.085 | 0.087 | 0.092 | 0.098 | 0.104 | 0.113 |
| Arsenic Ion | 0.197 | 0.221 | 0.253 | 0.292 | 0.311 | 0.401 |
| Nickel Ion | 0.456 | 0.695 | 0.862 | 1.021 | 1.166 | 1.552 |
| Chromium Ion | 0.288 | 0.411 | 0.522 | 0.611 | 0.712 | 0.893 |

### Comparative Example 2

Take 3 g of e-liquid Y and inject it into the atomizing cartridge of an open type e-cigarette, and the concentration changes of nicotine, menthol ice-cooling agent, β-damascenone essence, lead, cadmium, mercury, arsenic, nickel, and chromium in the e-liquid Y in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Comparative example 2, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 2994 | 2542 | 2124 | 1707 | 1286 | 897 |
| Menthol | 5880 | 4998 | 4174 | 3349 | 2527 | 1761 |
| β-damascenone | 990 | 842 | 701 | 562 | 424 | 297 |
| Lead Ion | 0.495 | 0.523 | 0.561 | 0.591 | 0.621 | 0.723 |
| Cadmium Ion | 0.192 | 0.257 | 0.288 | 0.319 | 0.357 | 0.425 |
| Mercury Ion | 0.087 | 0.089 | 0.093 | 0.099 | 0.112 | 0.119 |
| Arsenic Ion | 0.193 | 0.226 | 0.261 | 0.303 | 0.319 | 0.411 |
| Nickel Ion | 0.451 | 0.698 | 0.867 | 1.026 | 1.171 | 1.564 |
| Chromium Ion | 0.282 | 0.418 | 0.528 | 0.623 | 0.724 | 0.905 |

### Embodiment 1

Appropriate amount of activated carbon particles are immersed in concentrated nitric acid at 60° C. for 24 hours, removing and completely drying to produce modified activated carbon particles with enhanced surface carboxylic acid and hydroxyl groups.

10 grams of the surface-modified activated carbon particles, 60 grams of plant nicotine, 20 grams of linalool essence and 20 grams of WS-23 cooling agent, are put into a polytetrafluoroethylene container, and the container is sealed into a hydrothermal reactor, heating up to 70° C. and keeping for 10 minutes, turn off the power and cool naturally, take out the activated carbon particles and dry the surface in a nitrogen flow, and the activated carbon particles adsorbed with nicotine, linalool and WS-23 are prepared under high temperature and high pressure, weighing 13 grams, the calculated adsorption amount of the activated carbon particles is 30% relating to the own weight, marked as adsorption slow-release carrier A-1.

0.3 g of the adsorption slow-release carrier A-1 mixes with 2.7 g of the above e-liquid X to form an electronic atomization liquid composition, the weight share of the adsorption slow-release carrier in the electronic atomization liquid composition is 10%, and then add the electronic atomization liquid composition to the atomizing cartridge of an open type e-cigarette, and the concentration changes of nicotine, WS-23 ice-cooling agent, linalool essence, lead, cadmium, mercury, arsenic, nickel, and chromium in the e-liquid X in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 1, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 29910 | 30358 | 29904 | 29466 | 29071 | 27962 |
| WS-23 | 4850 | 4928 | 4847 | 4778 | 4713 | 4535 |
| Linalool | 4900 | 4971 | 4897 | 4824 | 4763 | 4587 |
| Lead Ion | 0.492 | 0.062 | 0.011 | 0.003 | 0.001 | 0 |
| Cadmium Ion | 0.198 | 0.025 | 0.004 | 0.001 | 0 | 0 |
| Mercury Ion | 0.085 | 0.011 | 0.002 | 0 | 0 | 0 |
| Arsenic Ion | 0.197 | 0.024 | 0.004 | 0.001 | 0 | 0 |
| Nickel Ion | 0.456 | 0.056 | 0.009 | 0.002 | 0.001 | 0 |
| Chromium Ion | 0.288 | 0.035 | 0.006 | 0.001 | 0 | 0 |

### Embodiment 2

10 grams of activated carbon particles of the same type as in the Embodiment 1 but without surface-modified by concentrated nitric acid, 60 grams of plant nicotine, 20 grams of linalool essence and 20 grams of WS-23 ice-cooling agent, are put into a PTFE container, and the container is sealed into a hydrothermal reactor, heating up to 70° C. and keeping for 10 minutes, turn off the power and cool naturally, take out the activated carbon particles and dry the surface in a nitrogen flow, and the activated carbon particles adsorbed with nicotine, linalool and WS-23 are prepared under high temperature and high pressure, weighing 11.3 grams, and the calculated adsorption amount of the activated carbon particles is 13% relating to the own weight, which are marked as the adsorption slow-release carrier A-2.

0.3 g of the adsorption slow-release carrier A-2 mixes with 2.7 g of the above e-liquid X to form an electronic atomization liquid composition, the weight of the adsorption slow-release carrier in the electronic atomization liquid composition is 10%, and then add the electronic atomization liquid composition to the atomizing cartridge of an open type e-cigarette, and the concentration changes of nicotine, WS-23 ice-cooling agent, linalool essence, lead, cadmium, mercury, arsenic, nickel, and chromium in the e-liquid X in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 2, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 29910 | 30149 | 29341 | 28683 | 27935 | 27277 |
| WS-23 | 4850 | 4888 | 4757 | 4651 | 4529 | 4423 |
| Linalool | 4900 | 4939 | 4806 | 4699 | 4577 | 4468 |
| Lead Ion | 0.492 | 0.125 | 0.041 | 0.021 | 0.011 | 0.005 |
| Cadmium Ion | 0.198 | 0.049 | 0.016 | 0.008 | 0.004 | 0.002 |
| Mercury Ion | 0.085 | 0.021 | 0.007 | 0.003 | 0.001 | 0 |
| Arsenic Ion | 0.197 | 0.048 | 0.015 | 0.007 | 0.003 | 0.001 |
| Nickel Ion | 0.456 | 0.113 | 0.037 | 0.018 | 0.009 | 0.004 |
| Chromium Ion | 0.288 | 0.071 | 0.024 | 0.012 | 0.005 | 0.003 |

### Embodiment 3

The nano-chitosan loaded molecular sieve particles are used as the composite adsorption slow-release carrier B. One gram of the adsorption slow-release carrier B is mixed into a plastic drum containing 1 ton of e-liquid X to form an electronic atomization liquid composition storing in airtight condition, the weight part of the adsorption slow-release carrier in the electronic atomization liquid composition is 0.0001%. The concentrations of lead, cadmium, mercury, arsenic, nickel, and chromium in e-liquid X are detected with the gas chromatography, inductively coupled plasma mass spectrometer and other instruments as follows at intervals of 10 days after adding the adsorption slow-release carrier B:

Embodiment 3, Concentration Unit: mg/kg

| | E-liquid | 10 | 20 | 30 | 40 | 100 |
|---|---|---|---|---|---|---|
| | X made | days | days | days | days | days |
| Lead Ion | 0.492 | 0.485 | 0.482 | 0.48 | 0.478 | 0.465 |
| Cadmium Ion | 0.198 | 0.184 | 0.173 | 0.166 | 0.161 | 0.142 |
| Mercury Ion | 0.085 | 0.074 | 0.069 | 0.065 | 0.061 | 0.046 |
| Arsenic Ion | 0.197 | 0.191 | 0.183 | 0.177 | 0.171 | 0.146 |
| Nickel Ion | 0.456 | 0.439 | 0.431 | 0.425 | 0.421 | 0.392 |
| Chromium Ion | 0.288 | 0.275 | 0.272 | 0.269 | 0.267 | 0.245 |

### Embodiment 4

A metal cube container with length, width and height of 10 cm is made, and a round hole with the diameter of 1 cm is left on the upper surface of the container, which can be completely closed with a rubber stopper. The mixed particles of 2 g of nano-chitosan loaded activated carbon, and 1 g of chitosan-bis(3-methylphenylcarbamate)-(butyramide) loaded molecular sieve, and 1 g of chitosan-bis(3,4-dichlorophenylcarbamate)-(butyramide) loaded zeolite, and 1 g of chitosan-bis(3,4-dichlorophenylcarbamate)-(cyclohexanecarboxamide) loaded zeolite, and 1 g of chitin loaded activated carbon, and 1 g of deacetylated chitin loaded molecular sieve, and 1 g of dibutyryl chitin loaded zeolite, and 1 g of chitin fiber loaded zeolite, and 1 g of camphor bark, are put at the bottom of the metal container, and the metal container is pumped to 0.95×105 Pascal from the round hole on the upper surface, that is, the negative pressure relative to the standard atmospheric pressure is about −6×10³ Pascal, and then closed with a rubber stopper. 1 g of the synthetic nicotine, 0.5 g of linalool essence and 0.5 g of WS-23 cooling agent, mixing evenly at room temperature, are injected into the inner wall of the metal container by piercing the rubber stopper by a needle tube. After 60 minutes, the rubber stopper is opened and the mixed particles of the above mentioned chitosan, chitosan derivatives, chitin, chitin derivatives and camphor tree bark are taken out. Then the mixed adsorption slow-release carriers pre-absorbed nicotine, linalool essence and WS-23 ice-cooling agent are prepared under the environment of normal temperature and low pressure, weighing 10.3 g, and the calculated adsorption amount of the mixed adsorption slow-release carrier is 3% relating to the own weight, marked as the adsorption slow-release carrier C. 0.15 g of the adsorption slow-release carrier C is added to 2.85 g of the above e-liquid X to form an electronic atomization liquid composition, the weight share of the adsorption slow-release carrier in the electronic atomization liquid composition is 5%, and then add the electronic atomization liquid composition to the atomizing cartridge of an open type electronic cigarette, and the concentration changes of nicotine, WS-23 ice-cooling agent, linalool essence, lead, cadmium, mercury, arsenic, nickel, and chromium in the e-liquid X in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 4, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 29910 | 30029 | 29041 | 28177 | 27241 | 25872 |
| WS-23 | 4850 | 4868 | 4707 | 4566 | 4415 | 4198 |
| Linalool | 4900 | 4989 | 4927 | 4862 | 4805 | 4707 |
| Lead Ion | 0.492 | 0.164 | 0.055 | 0.012 | 0.003 | 0.001 |
| Cadmium Ion | 0.198 | 0.065 | 0.016 | 0.004 | 0.001 | 0 |
| Mercury Ion | 0.085 | 0.028 | 0.009 | 0.002 | 0 | 0 |
| Arsenic Ion | 0.197 | 0.065 | 0.022 | 0.005 | 0.001 | 0 |
| Nickel Ion | 0.456 | 0.153 | 0.051 | 0.011 | 0.003 | 0.001 |
| Chromium Ion | 0.288 | 0.095 | 0.032 | 0.006 | 0.002 | 0 |

### Embodiment 5

Cut the fresh citrus peel into several granules with shapes of five-pointed star, love heart, letter A, the word LOVE, a certain logo, little rabbit, etc., and put 100 g of the citrus peel granules into a glass bottle. Add the mixture of 0.1 g of nicotine benzoate salt, 0.04 g of menthol ice-cooling agent and 0.06 g of β-damascenone essence to the surface of the citrus peel particles in the glass bottle at room temperature, close the glass bottle mouth and shake the glass bottle continuously for 20 minutes, whereby the mixed solution is evenly adsorbed on the surface of the citrus peel particles, and the citrus peel particles adsorbed with nicotine salt, menthol ice-cooling agent and β-damascenone essence are prepared under room temperature and normal pressure, weighing 100.1 g, and the calculated adsorption amount of nicotine salt, menthol ice-cooling agent and β-damascenone essence mixture by the citrus peel particles is 0.1% relating to the own weight, marked as adsorption slow-release carrier D.

27 g of the adsorption slow-release carrier D is mixed with 3 g of the above mentioned e-liquid Y to form an electronic atomization liquid composition, the weight share of the adsorption slow-release carrier in the electronic atomization liquid composition is 90%, and then add the electronic atomization liquid composition to the big atomizing cartridge of an open type e-cigarette, and the concentration changes of nicotine, menthol ice-cooling agent and β-damascenone essence, lead, cadmium, mercury, arsenic, nickel, and chromium in the e-liquid Y in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 5, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 2994 | 3294 | 3141 | 2987 | 2941 | 2834 |
| Menthol | 5880 | 6468 | 6178 | 5864 | 5776 | 5574 |
| β-damascenone | 990 | 1089 | 1037 | 988 | 973 | 939 |
| Lead Ion | 0.495 | 0.166 | 0.055 | 0.028 | 0.015 | 0.007 |
| Cadmium Ion | 0.192 | 0.065 | 0.021 | 0.011 | 0.005 | 0.003 |
| Mercury Ion | 0.087 | 0.028 | 0.009 | 0.004 | 0.002 | 0.001 |
| Arsenic Ion | 0.193 | 0.064 | 0.021 | 0.012 | 0.005 | 0.002 |
| Nickel Ion | 0.451 | 0.151 | 0.051 | 0.025 | 0.013 | 0.006 |
| Chromium Ion | 0.282 | 0.094 | 0.032 | 0.016 | 0.008 | 0.004 |

### Embodiment 6

0.2 g of nano-alumina loaded zeolite particles, 0.2 g of silica gel powder loaded activated carbon particles, 0.1 g of polyurethane foam particles, 0.1 g of activated alumina microspheres, 0.1 g of macroporous resin particles, 0.1 g of sepiolite particles, 0.1 g porous silica beads, and 0.1 g of montmorillonite loaded activated carbon particles are mixed together and marked as the adsorption slow-release carrier E, and 1 g of the adsorption slow-release carrier E is added to a bottle containing 99 g of the above mentioned e-liquid Y to form an electronic atomization liquid composition, the weight share of the adsorption slow-release carrier in the electronic atomization liquid composition is 1%, 3 g of the electronic atomization liquid composition is added to the atomizing cartridge of an open type e-cigarette after the e-liquid bottle shaken evenly, and the concentration changes of nicotine, menthol ice-cooling agent, β-damascenone essence, lead, cadmium, mercury, arsenic, nickel, and chromium in the e-liquid Y in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 6, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 2994 | 2754 | 2511 | 2304 | 2036 | 1348 |
| Menthol | 5880 | 5407 | 4938 | 4527 | 3998 | 2645 |
| β-damascenone | 990 | 910 | 831 | 762 | 673 | 446 |
| Lead Ion | 0.495 | 0.083 | 0.017 | 0.006 | 0.002 | 0.001 |
| Cadmium Ion | 0.192 | 0.032 | 0.006 | 0.002 | 0.001 | 0 |
| Mercury Ion | 0.087 | 0.015 | 0.003 | 0.001 | 0 | 0 |
| Arsenic Ion | 0.193 | 0.031 | 0.006 | 0.002 | 0.001 | 0 |
| Nickel Ion | 0.451 | 0.075 | 0.015 | 0.005 | 0.002 | 0.001 |
| Chromium Ion | 0.282 | 0.047 | 0.009 | 0.003 | 0.001 | 0 |

### Embodiment 7

100 g wood fiber particles are placed into a plastic bottle, and then spread a mixture of 0.006 g synthetic nicotine, 0.002 g menthol ice-cooling agent and 0.002 g β-damascenone essence on the inner surface of the plastic bottle cap, and seal the plastic bottle with the plastic bottle cap, put the plastic bottle in refrigerator at −10° C. for 1 minute and take it out, and then the wood fiber particles adsorbed with nicotiane, menthol ice-cooling agent and β-damascenone essence are produced under the environment of normal pressure and low temperature, weighing 100.001 g, and the calculated adsorption amount is 0.001% of the wood fiber particles weight, marked as adsorption slow-release carrier F. 0.9 g of the adsorption slow-release carrier F mixes with 2.1 g of the above mentioned e-liquid Y to form an electronic atomization liquid composition, the weight share of the adsorption slow-release carrier in the electronic atomization liquid composition is 30%, and then add the electronic atomization liquid composition to the atomizing cartridge of an open type e-cigarette, and the concentration changes of nicotine, menthol ice-cooling agent and β-damascenone essence, lead, cadmium, mercury, arsenic, nickel, and chromium in the e-liquid Y in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 7, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 2994 | 2943 | 2920 | 2844 | 2771 | 2548 |
| Menthol | 5880 | 5781 | 5735 | 5586 | 5443 | 5005 |
| β-damascenone | 990 | 973 | 965 | 941 | 916 | 843 |
| Lead Ion | 0.495 | 0.055 | 0.007 | 0.002 | 0 | 0 |
| Cadmium Ion | 0.192 | 0.021 | 0.003 | 0 | 0 | 0 |
| Mercury Ion | 0.087 | 0.009 | 0.001 | 0 | 0 | 0 |
| Arsenic Ion | 0.193 | 0.022 | 0.003 | 0 | 0 | 0 |
| Nickel Ion | 0.451 | 0.049 | 0.006 | 0.002 | 0.001 | 0 |
| Chromium Ion | 0.282 | 0.031 | 0.004 | 0.001 | 0 | 0 |

### Embodiment 8

0.072 g of tea leaves, 0.078 g of tobacco leaves, 0.074 g of mint leaves and 0.076 g of rose petals are mixed together and marked as the adsorption slow-release carrier G, and 0.3 g of the adsorption slow-release carrier G is added to 2.7 g of the e-liquid Y to form an electronic atomization liquid composition, the weight share of the adsorption slow-release carrier in the electronic atomization liquid composition is 10%, 3 g of this electronic atomization liquid composition is added to the atomizing cartridge of an open type e-cigarette, and the concentration changes of nicotine, menthol ice-cooling agent and β-damascenone essence, lead, cadmium, mercury, arsenic, nickel, and chromium in the e-liquid Y in the atomizing cartridge are detected with the gas chromatography, inductively coupled plasma mass spectrometer and other instruments after 0 puff, 50 puffs, 100 puffs, 150 puffs, 200 puffs and 500 puffs as follows:

Embodiment 8, Concentration Unit: mg/kg

| | 0 | 50 | 100 | 150 | 200 | 500 |
|---|---|---|---|---|---|---|
| | puff | puffs | puffs | puffs | puffs | puffs |
| Nicotine | 2994 | 3077 | 3038 | 2961 | 2881 | 2643 |
| Menthol | 5880 | 6044 | 5968 | 5815 | 5656 | 5192 |
| β-damascenone | 990 | 1015 | 1004 | 979 | 952 | 874 |
| Lead Ion | 0.495 | 0.476 | 0.457 | 0.439 | 0.421 | 0.352 |
| Cadmium Ion | 0.192 | 0.184 | 0.176 | 0.169 | 0.162 | 0.135 |
| Mercury Ion | 0.087 | 0.084 | 0.081 | 0.077 | 0.074 | 0.061 |
| Arsenic Ion | 0.193 | 0.185 | 0.178 | 0.171 | 0.164 | 0.132 |
| Nickel Ion | 0.451 | 0.433 | 0.416 | 0.399 | 0.382 | 0.311 |
| Chromium Ion | 0.282 | 0.271 | 0.262 | 0.251 | 0.243 | 0.202 |

### Analysis of Results

The nicotine, WS-23 ice-cooling agent and linalool essence are escaping and losing very quickly after the e-liquid X is directly added to the e-cigarette in Comparative Example 1, and the concentrations of these volatile substances in the e-liquid of Comparative Example 1 after 500 puffs are all lower than those in the Embodiment 1, the Embodiment 2 and the Embodiment 4 after 500 puffs under the same conditions.

The nicotine, menthol ice-cooling agent and β-damascenone essence are escaping and losing very quickly after the e-liquid Y is directly added to the e-cigarette in Comparative Example 2, and the concentrations of these volatile substances in the e-liquid of Comparative Example 2 after 500 puffs are all lower than those in the Embodiment 5, the Embodiment 6, the Embodiment 7 and the Embodiment 8 after 500 puffs under the same conditions.

The ion concentrations of harmful elements of lead, cadmium, mercury, arsenic, nickel, and chromium in the e-liquid atomizing cartridges in Comparative Example 1 and Comparative Example 2 all show increasing trend, indicating that in addition to the harmful elements originally contains in the e-liquid, parts of the atomizing cartridge which contacting with the e-liquid gradually dissolve out further more harmful elements into the e-liquid. These parts of the atomizing cartridge may be the shell of the atomizer, the metal aerosol guide tube, the e-liquid storage tank, the metal heating wire, the heating resistor layer, the atomizing core or even the sealing silica gel, etc.

Comparing the embodiments and the comparative examples, the electronic atomization liquid composition of the present invention can slow down the escaping and losing of volatile substances such as nicotine, cooling agent and essence in the e-liquid by utilizing the surface and pore properties of the adsorption slow-release carrier contained in it, and the adsorption slow-release carrier can also pre-adsorb an appropriate amount of nicotine salt, nicotine, cooling agent and essence, as an effective supplement for the volatile substances in the e-liquid. Vaping test by a number of users: the middle and late using experiences of the electronic atomization liquid composition in the embodiments are indeed better than those in the comparative examples. The reason is that the electronic atomization liquid composition can replenish the nicotine, cooling agent and essence into the e-liquid through the adsorption slow-release carrier during the middle and late stages of the using, so as to maintain the consistency of the taste of the e-cigarettes.

Under the same comparison conditions, the activated carbon modified with concentrated nitric acid in the Embodiment 1 is used as the adsorption slow-release carrier, and the ability to adsorb volatile substances and harmful elements such as lead, cadmium, mercury, arsenic, nickel, and chromium is significantly better than those of the Embodiment 2, which proves that through the modification technology, the capacity of the surface and pore wall of the adsorption slow-release carrier to adsorb nicotine, ice-cooling agent and essence can be improved, as well as the ability to adsorb and complex harmful elements such as heavy metals can also be enhanced.

The nano-chitosan loaded molecular sieve is added to the e-liquid X as a composite adsorption slow-release carrier to form an electronic atomization liquid composition in the Embodiment 3. The adsorption and slow-release of nicotine, linalool essence and WS-23 cooling agent in e-liquid X are in a state of dynamic equilibrium, the adsorption slow-release carrier has no practical significance in balancing the concentration of volatile substances in e-liquid when the plastic drum is completely sealed, so no testing or analysis is done. However, the adsorption slow-release carrier can adsorb and complex harmful elements such as lead, cadmium, mercury, arsenic, nickel, chromium, etc., to reduce the concentration of these harmful elements in the e-liquid.

In the Embodiment 4, the mixed adsorption slow-release carrier in the electronic atomization liquid composition contains linalool bark particles, and the linalool bark will slowly release linalool, which can effectively replenish the linalool essence that gradually lost in the e-liquid.

Although the wood fiber particles in the Embodiment 7 have only 0.001% adsorption in advance of nicotine, menthol ice-cooling agent and β-damascenone essence relative to the own weight, they can continue to absorb the nicotine, menthol ice-cooling agent and β-damascenone essence in the e-liquid Y after being added as the adsorption retardation carrier to form the electronic atomization liquid composition, and then release these substances slowly when the concentration of volatile substances in the e-liquid Y gradually decreasing, so as to slow down the fading rate of these substances in the e-liquid during the whole vaping process.

In the Embodiment 8, the mixed bio-based adsorption slow-release carriers in the electronic atomization liquid composition will slowly release the adsorbed natural nicotine, menthol ice-cooling agent, and β-damascenone essence to the e-liquid, replenishing these volatile substances gradually dissipated from the e-liquid. In addition, biomass such as tea leaves and tobacco leaves have been observed to have a large number of tiny pores, which can reduce the concentration and content of harmful elements such as lead, cadmium, mercury, arsenic, nickel, chromium, etc. in e-liquid, although the ability of adsorbing these harmful elements is small.

### Supplementary Experiments of Composite Adsorption Slow-Release Carrier:

The micrometre and nanometre small size adsorption slow-release carriers load onto the surface of the large-size adsorption slow-release carriers to prepare the composite adsorption slow-release carriers.

The specific experimental procedures for preparing the composite adsorption slow-release carriers as examples are as follows, these preparations have been reported by a lot of literature, and the techniques for their preparation are outside the protection scope of this patent:

1. Bentonite loading activated carbon: add bentonite and deionized water according to the solid-liquid mass ratio of 1:10 to a beaker, stirring for 10 minutes, whereby the bentonite dispersion is uniform, aging one hour and then filtering and drying; add one part by weight of dried bentonite to a 10 g/L dodecyltrimethylammonium bromide solution, and then add 1~5 parts by weight of activated carbon particles, stirring at 60° C. for 2 hours. Drying at 100° C. after filtering, and put these particles into the muffle furnace at 300° C. for 1 hour, the bentonite loading onto the surface of the activated carbon is produced as a composite adsorption slow-release carrier.

2. Diatomite loading activated carbon: activated carbon particles, diatomite powder and deionized water according to 1:(1~10):(1~3) by weight are mixed and stirred to form a viscous billet, and the viscous billet is made into columns, spheres, and other samples with molds, naturally drying for 1 hour, and put samples into a muffle furnace to be calcinated at 700° C. for 2 hours, then cooling in the furnace, and the diatomite loading onto the surface of the activated carbon is produced as a composite adsorption slow-release carrier. This method is also applicable to montmorillonite and sepiolite loading onto the surface of activated carbon, zeolite and molecular sieve to produce composite adsorption slow-release carriers.

3. Silica gel powder loading activated carbon: activated carbon particles, silica gel powder and 30% hydrogen peroxide by weight of 1:(1~5):(1~2) are mixed and stirred to form a viscous billet, the viscous billet is made into columns, spheres, and other samples with molds, natural drying for 1 hour, and place samples into a muffle furnace to be calcinated at 150° C. for 1 hour, cooling with the furnace, the silica gel powder loading onto the surface of activated carbon is produced as a composite adsorption slow-release carrier.

4. Nano-alumina loading zeolite: aluminum powder is dissolved into ammonium bicarbonate solution to obtain white aluminum hydroxide sol precipitation, and the supernatant is removed. The zeolite and the appropriate amount of aluminum hydroxide sol are stirred uniformly to form a viscous billet, the viscous billet is made into columns, spheres, and other samples with molds, and place samples into the muffle furnace to be calcinated at 700° C. for 1 hour through nitrogen protection, with the furnace cooling, the nano-alumina loading onto the surface of the zeolite is produced as a composite adsorption slow-release carrier.

5. Carbon nanotube loading alumina: carbon nanotubes are put into concentrated

nitric acid and stirring at 65° C. for 10 hours, cooling down to room temperature, wishing to neutral and drying, surface modified carbon nanotubes with increased hydroxyl groups are produced. The modified carbon nanotubes are added into Al(NO3)3 aqueous solution, stirring and mixing for 2 hours, and then the solution is put into a oven, drying at 100° C. to obtain spongy and fluffy tissue samples, which are then uniformly placed in a quartz boat, and then place into a tube furnace, and then is roasted at 450° C. for 2 hours in the atmosphere of N2, and then cooling down to room temperature, the nano-alumina loading onto the surface of the zeolite is produced as a composite adsorption slow-release carrier.

6. Chitosan loading molecular sieve: dissolve 5 g chitosan into 4% acetic acid solution, add 100 g molecular sieve and fully stir to a paste, extrude particles with a granulator and dry at 100° C. to produce chitosan loaded onto the surface of the molecular sieve as a composite adsorption slow-release carrier. The process is similar for chitosan derivatives, chitin and its derivatives loading onto the surface of zeolite, activated carbon and so on to form the composite adsorption slow-release carriers, solvents is the unique difference, for example, chitin and its derivatives are preferably dissolved into acetic acid and other acids.

In addition, in order to complete the above experiments, the raw materials used in the present invention are mainly purchased from commercial products or collected from nature, specifically: zeolite particles with length of 1000-5000 microns, molecular sieve particles with diameter of 1000-2000 microns, sepiolite particles with 20-45 microns, bentonites with particle size of 200-1000 microns, montmorillonites with particle size of 0.2-1 micron, diatomites with particle size of 30-300 microns, silica gel powder with a particle size of 2-100 micron, porous silica beads with diameter of 100-200 microns, activated carbon with length of 1000-5000 microns, activated alumina microspheres with diameter of 3000-8000 microns, alumina nanoparticles powder with size of 0.01-0.1 micron, carbon nanotubes with length of 0.1-100 micron, polyurethane foam with particle size of 1000-5000 microns, commercial macroporous resins with particle size of 300-1000 microns, chitosan and its derivatives with particle size of 0.02-1 micron, chitin and its derivatives with particle size of 300-1000 microns, wood fiber particles with particle size of 1000-2000 microns, fruit peels, fruit grains, barks, leaves, tea leaves, tea stalks, tobacco leaves, tobacco stalks, mint leaves, flower leaves, buds, stamens, petals, flowers of length 1000-30,000 microns, and the solid raw materials of the above sizes do not limit the application of similar raw materials of other sizes in the electronic atomization liquid compositions of the present invention.

In summary, the present invention discloses an electronic atomization liquid composition and packaging container thereof, which are beneficial to improve the using experience in the middle and late stages of e-cigarettes, and can effectively absorb harmful elements such as lead, cadmium, mercury, arsenic, nickel, chromium, etc., reducing the content of these harmful elements in the e-liquid, and improve the safety of e-cigarettes.

The above description are only some the embodiments of the present invention, and are not intended to limit the patent scope of the present invention. Any equivalent structure or equivalent process transformation made by using the content of the description of the present invention, and directly or indirectly applied in other related technical fields, shall be all included in the patent protection scope of the present invention.

What is claimed is:

1. A packaging container, wherein the packaging container contains an electronic atomization liquid composition; the electronic atomization liquid composition comprises an electronic liquid, and an adsorption slow-release carrier in a solid state; the weight percent of the electronic liquid in the electronic atomization liquid composition is between 10% and 99.9999%, the weight percent of the adsorption slow-release carrier in the electronic atomization liquid composition is between 0.0001% and 90%; the adsorption slow-release carrier is present in the electronic liquid; the adsorption slow-release carrier comprises a bio-based adsorption slow-release carrier that comprises at least one of biological fibers and biological cells; at least one of essence, nicotine, and nicotine salt is naturally pre-adsorbed in the bio-based adsorption slow-release carrier before the adsorption slow-release carrier is mixed with the electronic liquid to form the electronic atomization liquid composition; the adsorption slow-release carrier does not comprise an atomizing core.

2. The packaging container according to claim 1, wherein the packaging container comprises at least one of a barrel, a bottle, and an atomizing cartridge.

3. The packaging container according to claim 2, wherein the atomizing cartridge is one of a cartridge-changing closed type electronic liquid atomizing cartridge, a cartridge-changing open type electronic liquid atomizing cartridge, a disposable electronic cigarette closed type electronic liquid storage cartridge, and an electronic liquid storage cartridge for a high-power electronic cigarette.

4. The packaging container according to claim 1, wherein the bio-based adsorption slow-release carrier comprises at least one of fruit peels, fruit grains, tree bark, tree leaves, tea leaves, tea stems, tobacco leaves, tobacco stems, and flowers.

5. The packaging container according to claim 1, wherein the electronic liquid comprises at least one of nicotine, nicotine salt, propylene glycol, glycerin, essence, and water.
